(19) United States
(12) Patent Application Publication
(10) Pub. No.: US 2005/0139585 A1
(43) Pub. Date: Jun. 30, 2005

(54) Building eaves heater for metal roof

(76) Inventor: Leonard V. Knappmiller, West Rutland, VT (US)

Correspondence Address: KEVIN ELLICOTT, SUITE 112, 1 SCALE AVE, RUTLAND, VT, 05701, US

(21) Appl. No.: 10/749,592

(22) Filed: Dec. 31, 2003

(51) Int. Cl. H05B 3/00

(52) U.S. Cl. 219/213

(57) ABSTRACT

A building eaves heater for metal roof comprising a hollow sheathe, a heating element located within the metal sheathe and tabs for attaching the metal sheathe to the metal roof.

### CROSS REFERENCE TO OTHER APPLICATIONS

This is the first submission of an application for this article of manufacture. There are no other applications, provisional or non provisional.

### FEDERALLY SPONSORED RESEARCH AND DEVELOPMENT

There are no federally sponsored or funded research or development projects or undertakings in any way associated with the instant invention.

### BACKGROUND OF THE INVENTION

1. Field of the Invention

The instant invention relates to that field of devices consisting of articles of manufacture known as heaters and de-icers. Specifically, the instant invention is an eaves mounted heater for use on a building having a metal roof

2. Background Information

The prior art known to the Inventor discloses that there have been numerous attempts to prevent the build up of ice along the terminating edge (the edge most distant from the roof peak, or “overhang”) on various structure roofs. Among the sort of devices intended to prevent the build up of ice and snow along the terminating edges of a roof are those which are placed on the outer surface of the roofing material (e.g., roof shingles).

It is well known that the purpose of such devices is to prevent ice from forming at the terminating edge of a roof, a condition which leads to what is commonly known as an “ice dam”. Ice building up along the terminating edges of a roof (proximate to the eaves) frequently traps snow and prevents it from falling off the roof as latent heat within the structure melts said snow, the snow returning to liquid water unless the ambient air temperature is sufficiently cool so as to re-freeze it. This, in turn, often leads to the liquid water being forced through the roof through various small openings, the water then leaking inside the structure.

To prevent this from occurring, there have been attempts to fabricate “nets” constructed of materials which generate heat, and placing the net along the terminating edge of the roof.

While these nets can be useful to prevent the formation of ice damns, they have the very serious drawback of being in the way should one wish to shovel snow and ice off the roof, or use a so-called roof rake to reach up onto the roof and pull the snow clear from the terminating edge. Because they are mounted on top of the roof surface, any attempt to use a snow shovel or roof rake to remove built up snow must be done with the greatest care, or the web is highly likely to be damaged in the process.

### SUMMARY OF THE INVENTION

The instant invention is an eaves mounted heater intended to prevent the build up of ice and snow along the terminating edges of metal roofs. For the first time, ice which begins to form along the terminating edges of a metal roof will be melted by a device not atop the roof, but mounted on the underside of the terminating edges of the metal roof, under what is generally referred to as the eave (the portion of the roof which overhangs and extends outwardly past the supporting wall). Thus, by mounting the instant invention on the under side of the roof, there is no impediment to using a roof rake or shovel to remove snow from the roof itself.

Furthermore, in the preferred embodiment of the invention, the building eaves heater is encased within a protective sheathe, ensuring that the heating element is less likely to come into direct contact with snow and ice, and thus preventing any build up on the heating element. Encasement in said manner has the further benefits of reducing the likelihood that the device will be damaged should it become necessary to shovel or rake snow from atop the roof. Said invention may also be essentially modular in its construction, allowing the user of said device to custom fit the device to buildings of differing lengths, and to utilize heating elements which consume greater or lesser wattages of electricity, thereby modifying the heat produced by the heating element as well as supplying appropriate amounts of electricity for heating elements of a variety of lengths. For example, it is believed desirable for a 25 foot long heating element to be constructed to utilize 150 watts of electricity.

A first object of the instant invention, therefore, is to provide for a device which will prevent the build up of snow and ice along the terminating edge of a metal roof.

This objective is accomplished by fabricating a heating element which is placed within a preferably metal box-like sheath, the metal box-like sheathe then being fastened on the underside of the metal roof When the heating element is energized, heat is generated by the heating element, heating the box-like sheath in turn, the box-like sheath then transferring said heat to the metal roof so that ice and snow overlying the portion of the roof to which the device is attached is melted and does not become an ice dam.

A second objective of the invention is to provide for a device capable of melting the snow and ice which builds up along the terminating edge of a metal roof and which at the same time does not in any way hinder the removal of snow or ice from along that terminating edge.

This objective is accomplished by fabricating a heating element which is placed within a preferably metal box-like sheath, the metal box-like sheathe then being fastened on the underside of the metal roof. By fastening the device under the roof, it does not in any way obstruct or hinder the removal of snow or ice from atop the roof when one uses a snow shovel or roof rake.

A third objective of the invention is to provide for a device capable of melting the snow and ice which builds up along the terminating edge of a metal roof and which at the same time is unlikely to be damaged during snow removal while using a roof rake or snow shovel.

This objective is accomplished by fabricating a heating element which is placed within a preferably metal box-like sheath, the metal box-like sheathe then being fastened on the underside of the metal roof. By fastening the device under the roof, it is nearly impossible to damage said device in the event that one chooses to use a snow shovel or snow rake to remove built up snow and or ice from the roof.

A fourth objective of the invention is to provide for a device capable of melting the snow and ice which builds up along the terminating edge of a metal roof and which may be custom fit to roofs having differing lengths.

This objective is accomplished by fabricating a first heating element having a pair of opposing ends, the first heating element having at one end preferably a duplex connector and at the opposite end a male or female connector and a second heating element also having a pair of opposing ends, the second heating element having at one end a male connector and at the other end a female connector such that the second heating element may be electrically connected to the first heating element. The first and second heating elements once so connected may be placed within the metal box-like sheathe and the assembly fastened to the underside of a metal roof.

By adding a third, fourth, and etc. heating elements, and using a box-like sheathe of greater length and or multiple sheathes, it is possible to custom fit the device to varying sized metal roofs.

### A DESCRIPTION OF THE DRAWINGS

FIG. 1 is a plan view of the heating element of preferred embodiment of the instant invention.

FIG. 2 is a perspective view of the sheathe of the preferred embodiment of the instant invention.

FIG. 3 is a close up partial cut away view of the instant invention.

FIG. 4 is an elevational view of the instant invention installed on a building.

FIG. 5 is a plan view of a second embodiment of the heating element.

FIG. 6 is an elevational view of the first end of the sheathe.

FIG. 7 is a perspective view of a bracket.

FIG. 8 is an overhead view of two sheathes butted together along with the bracket.

### A DESCRIPTION OF THE PREFERRED EMBODIMENT

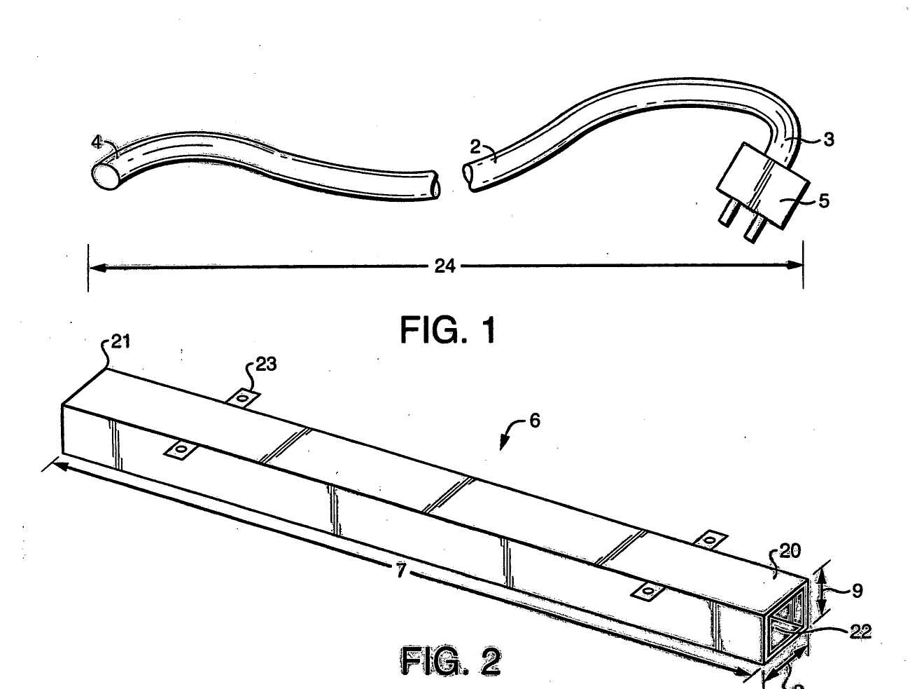

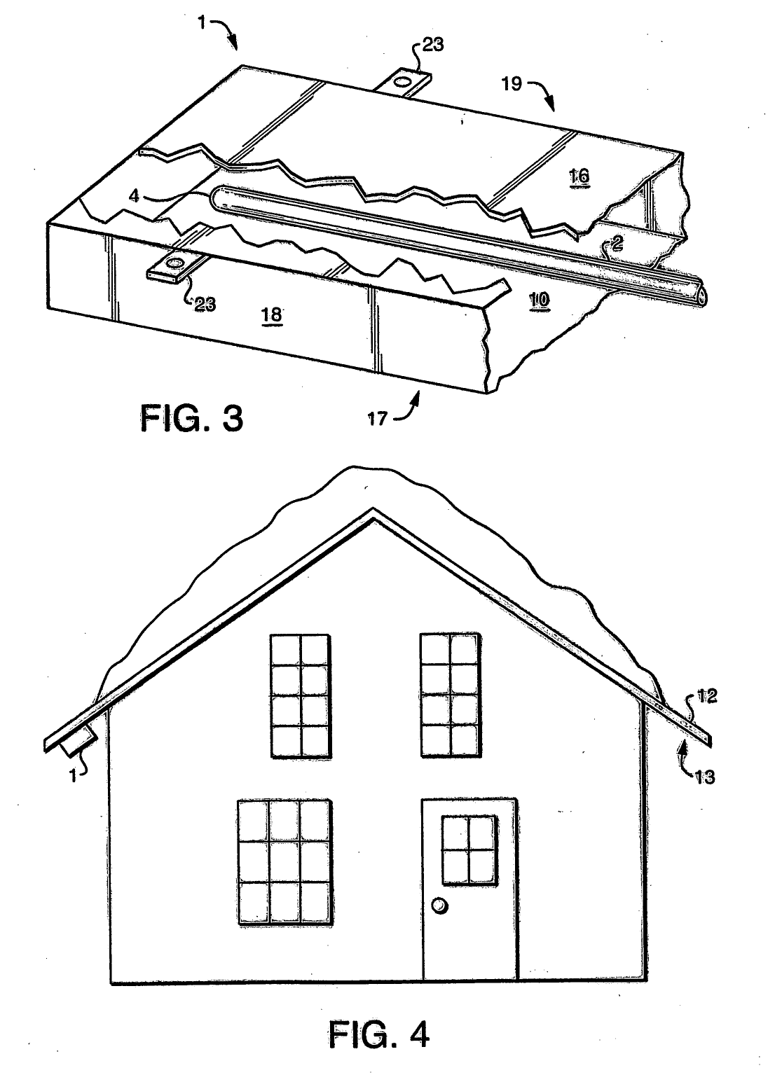

As per FIGS. 1 and 3, in the preferred embodiment, a building eaves heater (1) for a metal roof includes a first heating element (2) having a first end (3) and an opposite second end (4). The first heating element first end having an electrical connection means, preferably a duplex connector (the so-called “male” connector of the sort generally having two blades and often having a third grounding blade). In the preferred embodiment, the heating element is of the commercially available variety, commonly known as a “silicone rubber heating element”. Obviously, the heating element has heating element length. The heating element length may easily be varied according to manufacturing limitations and user requirements, and in the preferred embodiment is 25 feet long (and preferably 1 inch wide). While it is preferable to use a duplex connector in order to provide electricity to the heating element, it is obviously just as useful to have the heating element end in bare wires, and connect the bare wires to an electrical line in the building, effectively splicing the heating element into the building's electrical supply, or even including a switch between the building's electrical system (wiring within the building) and the heating element to allow for turning the heating element on and off as desired. Simply splicing wires together in this fashion should be understood to mean that the bare wires at the end of the heating element are the “electrical connection means”.

As per FIGS. 2, 3, 4 and 6, the instant invention further includes a sheathe (6) In the preferred embodiment, the sheathe is a metal box-like sheathe (casing) having length (7), width (8), height (9), a sheath first end (20) and an opposite sheathe second end (21). Furthermore, the sheathe (6) has a hollow interior (10) to permit the insertion within the sheathe of the heating element. In the preferred embodiment, the sheathe is box-like and therefore has a top wall (16) an opposite bottom wall (17), a left side wall (18) and an opposite right side wall (19). The sheathe length (7) may be varied to accommodate the requirements of different length buildings having metal roofs.

It is believed desirable to include an opening (22) passing through the sheathe first end so that the heating element may easily be inserted into the sheathe hollow interior, and removed therefrom when desired. Obviously, the sheathe further has sheathe wall thickness (11), the sheathe wall thickness in the preferred embodiment being 14 gauge or 0.078 inch. While wall thickness (11) is equal in the top, bottom, left and right sidewalls in the preferred embodiment, it is entirely possible to vary the thicknesses without departing from the scope of the claims. Furthermore, in the preferred embodiment the sheathe (6) is constructed of steel (preferably galvanized or stainless, so-called), so that it is substantially rigid and does not flex, bend or warp once attached to the building. However, this material is not a requirement, and other materials could easily be substituted. The heating element (2), once so encased within the sheathe is thereby protected from damage by water, snow, ice and mechanical means such as being scratched, scraped or cut by snow and ice clearing implements (snow shovels, roof rakes and the like). It should be obvious to one skilled in the art that while the preferred embodiment is described as incorporating a sheath which is metal, box-like and appears overall rectangular in form (both overall and cross sectionally), it could take a wide variety of forms including cross sectionally square, and cross sectionally round or oval. The precise geometric form is unimportant so long as the device may be fasted under the eave (12), and be in contact with the underside of the metal roof (13). Obviously, a square or rectangular cross section is preferable in order to maximize the surface area contact between the sheathe and the eave.

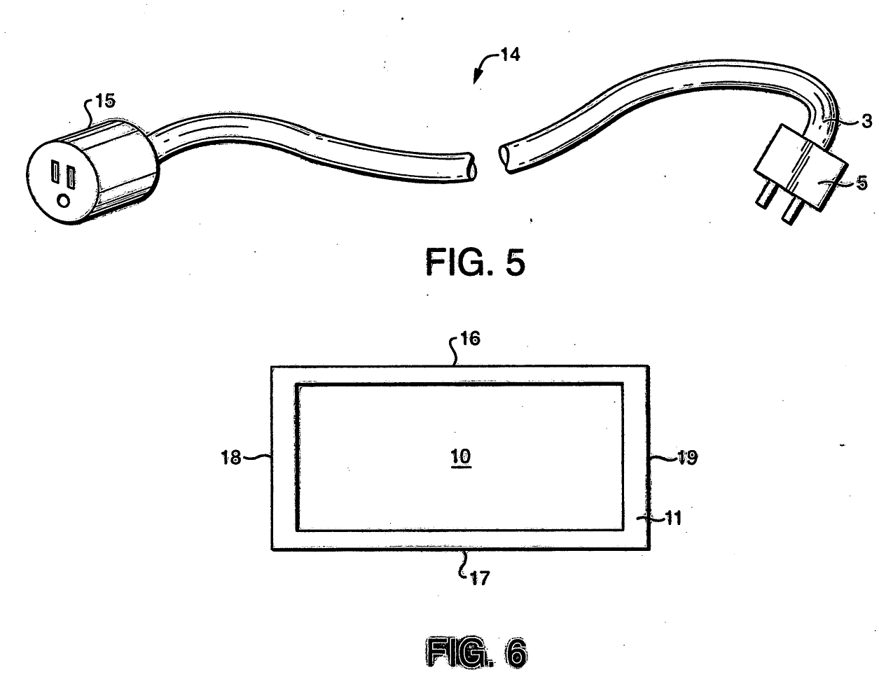

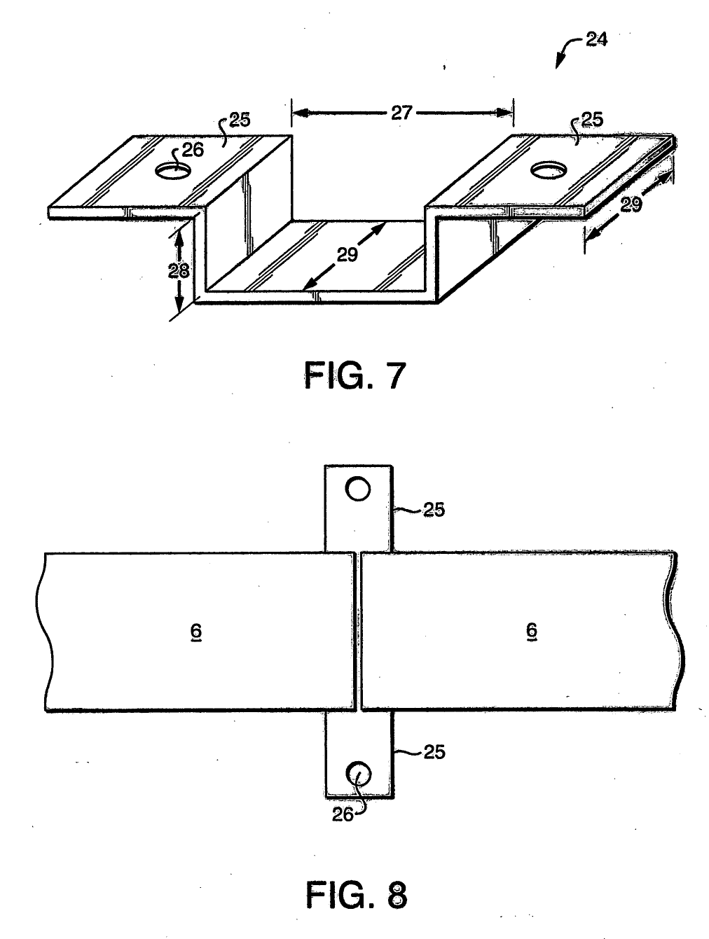

In another embodiment of the instant invention, as per FIG. 5, a second heating element (14) having a first end and an opposite second end may include at its second end (4) a second electrical connection means (15) such as a so-called “female” duplex connector. This form of electrical connector permits the insertion thereinto of a male duplex connector, allowing electrical current to pass freely from one heating element connected to another heating element in this fashion. By having two or more of these second embodiment heating elements so connected to one another, it is possible to provide for a heating element of varying total lengths. Obviously, one may utilize this invention with one heating element, two, or even a plurality of heating elements. Whether the first and second (or a plurality of) heating elements are electrically connected to one another in series or parallel will be largely dictated by power requirements and total length of the device desired, however, those skilled in the art will immediately recognize which is preferred according to mere design choice. Furthermore, it is equally a matter of choice as to whether to use such “duplex” type connectors, or simply splice each of the heating elements together using, for example, electrical tape and or wire nuts. Furthermore, it is entirely possible to have the opening (22) which passes through the first end in the preferred embodiment, instead pass through one of the other sheathe walls. So long as the heating element may be threaded into the hollow interior of the sheathe, the precise placement of the opening is a matter of design choice.

Use of the instant invention in its various embodiments may now be fully understood as per FIGS. 1, 2, 3, 4, 5, and 6. The heating element (2) is threaded through the sheathe first end opening (22) into the hollow interior of the sheathe such that the heating element second end (4) is proximate to the sheathe second end (21), and the heating element first end (5) is proximate to the sheathe first end (20). The heating element, once placed into the hollow interior of the sheathe will be in contact with at least one of the sheathe walls. The assembled device is then attached to the underside (13) of a metal roof eave (12) such that the sheathe top wall (16) is in contact with the metal roof underside (13). Attachment of the device to the roof may be accomplished by including sheathe attachment means (23), perhaps the simplest being tabs or ears which are little more than flattened pieces of metal securely affixed to the sheathe (6) and which have a hole passing therethrough to permit a connector such as a sheet metal screw to be extend through the hole and be screwed into the roof. Obviously, the attachment of the device to the underside of the roof could be accomplished in a great variety of ways, and so long as the device may be secured to the underside of the roof and not warp, bend or come loose from the roof, the precise means chosen is unimportant.

As was noted above, it may be desirable to include more than one sheathe when attaching the device to a roof eave. This may be easily accomplished as noted above, by placing a pair of sheathes end to end. Obviously, when two or more sheathes are used together, butted end to end, the second end (21) of at least one of the sheathes must have an opening identical to the first end (20) so that the heating element (2) may extend the entire length of the sheathes which are so butted together. That is, the opening (22) found on the first end (20) will also be found on the second end (21). Sheathes butted together, end to end like this, are aligned with one another and give the appearance of being one long sheathe. When arranging sheathes end to end in this fashion, it is believed desirable to include at least one sheath bracket (24). The sheath bracket in its simplest form may be an essentially “U” shaped, flattened body having tabs or ears (25) in the same manner as the sheathe attachment means (23). The sheathe bracket obviously must be sized and shaped to correspond to the size and shape of the sheathe itself. When the sheathe has a rectangular cross section, the sheathe bracket can be similarly shaped. The bracket may then be fitted to the sheathe, and used both to lend stability to the joint where the two sheathes are butted together as well as, by virtue of tabs or ears having holes (26) therethrough as do the sheathe attachment means, be used to attach the two sheathes to the roof. Obviously, where the sheathe has a width (8) of, for example six inches, the sheathe bracket width (27) will be just slightly greater than six inches so as to snugly receive the sheathe bracket. Also, when the sheathe has a height of, for example, four inches, the sheathe bracket height (28) should be slightly greater than four inches so that the bracket may be used to firmly attach the sheathe to the eave, and at the same time hold the pair of sheathes tightly against the roof so that they do not flex relative to one another. It is believed that in the preferred embodiment, the sheathe bracket should have a length (29) of approximately one to two inches.

Once the heating element is energized, that is, electrical current is provided to the heating element from a power source, the heating element will begin to generate heat. The heat so generated will be transferred from the heating element to at least one of the sheathe walls directly, and the sheathe will in turn become heated by the heating element. The heated sheathe will then transfer the heat to the underside of the metal roof with which it is in contact. The area of the metal roof which is in contact with the sheathe (and generally proximate to the to the sheathe) will then be heated, melting any snow or ice which is located on that portion of the metal roof, thus clearing that portion of the metal roof of snow and or ice to prevent ice dams from forming.

1. A building eves heater comprising;
A. a heating element,
I. the heating element having a first end and an opposite second end,
a. the first end having an electrical connection means,
II. the heating element having length,
B. a sheathe,
I. the sheathe having a hollow interior, a first end and an opposite second end,
a. the sheathe having an opening passing through the first end for communicating with the hollow interior,
b. the heating element being located within the hollow interior,
i. the heating element second end and the sheathe second end being proximate to one another,
II. the sheathe having length,
a. the sheathe length being less than the heating element length so that the heating element electrical connection means extends through the sheath first end opening and out of the sheathe hollow interior,
C. sheathe attachment means,
I. the sheathe attachment means permitting attachment of the sheathe to an underside of a metal roof.

2. A building eves heater according to claim 1, further comprising;
A. the heating element being a silicone rubber heating element.

3. A building eves heater according to claim 1, further comprising;
A. the heating element having a length of approximately twenty five feet,
B. the heating element having width,
I. the heating element width being approximately one inch.

4. A building eves heater comprising;
A. a heating element and a second heating element,
I. the heating element and second heating element each having a first end and an opposite second end,
a. the first end having an electrical connection means,
b. the second end having a second electrical connection means,
c. the heating element and the second heating element being electrically connected to each other such that the first end electrical connection means is electrically connected to the second heating element second end second electrical connection means,
II. the heating element and second heating element each having length,
B. a sheathe,
I. the sheathe having a hollow interior, a first end and an opposite second end,
a. the sheathe having an opening passing through the first end for communicating with the hollow interior,
b. the first heating element and second heating element being located within the hollow interior,
i. the heating element second end and the sheathe second end being proximate to one another,
II. the sheathe having length,
a. the sheathe length being less than the heating element length so that the second heating element first end second electrical connection means extends through the sheath first end opening and out of the sheathe hollow interior,
C. sheathe attachment means,.
I. the sheathe attachment means permitting attachment of the sheathe to an underside of a metal roof

5. A building eves heater comprising;
A. a plurality of heating elements,
I. the heating elements each having a first end and an opposite second end,
a. the first end having an electrical connection means,
b. the second end having a second electrical connection means,
II. the heating elements each having length,
III. the heating elements being electrically connected to one another,
B. a sheathe,
I. the sheathe having a hollow interior, a first end and an opposite second end,
a. the sheathe having an opening passing through the first end for communicating with the hollow interior,
b. the heating elements being located within the hollow interior,
II. the sheathe having length,
a. the sheathe length being less than the heating element length so that one heating element electrical connection means extends through the sheath first end opening and out of the sheathe hollow interior,
C. sheathe attachment means,
I. the sheathe attachment means permitting attachment of the sheathe to an underside of a metal roof,
a. the sheathe attachment means being a flattened piece of metal having a hole passing therethrough

6. A building eves heater comprising;
A. a plurality of heating elements,
I. the heating elements each having a first end and an opposite second end,
a. the first end having an electrical connection means,
b. the second end having a second electrical connection means,
II. the heating elements each having length,
III. the heating elements being electrically connected to one another,
B. at least a pair of sheathes,
I. the sheathes having a hollow interior, a first end and an opposite second end,
II. the sheathes being butted together,
a. the heating elements being located within and extending through the hollow interior,
III. the sheathes having length,
C. sheathe attachment means,
I. the sheathe attachment means permitting attachment of the sheathe to an underside of a metal roof,
a. the sheathe attachment means being a flattened piece of metal having a hole passing therethrough,

7. A building eves heater according to claim 6, further comprising;
A. a sheathe bracket,
I. the sheathe bracket supporting the butted together sheathes and attaching the sheathes to the underside of the metal roof.
